(19) United States
(12) Patent Application Publication
(10) Pub. No.: US 2026/0222687 A1
(43) Pub. Date: Jul. 30, 2026

(54) INFORMATION PROCESSING APPARATUS, IMAGE CAPTURING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: SHIGEHARU AOKI, Kanagawa (JP)

(21) Appl. No.: 19/442,073

(22) Filed: Jan. 7, 2026

(30) Foreign Application Priority Data
Jan. 24, 2025 (JP) 2025-010643

(51) Int. Cl. H04N 23/68; H04N 23/71; H04N 23/73; H04N 25/773

(52) U.S. Cl. CPC H04N 23/684; H04N 23/6811; H04N 23/71; H04N 23/73; H04N 25/773

(57) ABSTRACT

An information processing apparatus for controlling an image capturing apparatus including a photoelectric conversion element configured to generate an image signal by counting a pulse signal corresponding to incidence of light, the information processing apparatus operates as an exposure period control unit configured to control an exposure period of a main frame based on a main period as the exposure period of the main frame; a blur detection unit configured to detect an object blur for each unit period shorter than the main period by reading out an image signal of an exposed sub-frame for a sub-period from a start of exposure to an end of the unit period; and an output unit configured to output, based on a result of the blur detection, an output signal based on an image signal selected from one of the main frame and the sub-frame.

### BACKGROUND

### Field of the Technology

The present disclosure relates to control of an image capturing apparatus.

### Description of the Related Art

In shooting using an image capturing apparatus, it is necessary to appropriately set exposure in accordance with an object, a shooting scene, and the like. Exposure is mainly set based on at least one of a shutter speed, f-number, and sensitivity. If a target object is properly exposed, it is necessary to appropriately combine these elements. In general, when the shutter speed is low, a camera shake and an object blur readily occur. If the shutter speed is increased to prevent a camera shake and an object blur from occurring, it is possible to maintain proper exposure by increasing the sensitivity accordingly, but noise increases due to an increase in sensitivity. Since the shutter speed and the sensitivity are in opposition to a blur and noise, a skilled technique is required to appropriately set exposure in accordance with an object and a shooting scene.

A recent image capturing apparatus is provided with a mode of automatically setting exposure in accordance with a photometric result, and can appropriately set exposure for each shooting scene. However, since the control is executed to set exposure based on a photometric result, even if an object suddenly starts to move, the photometric result remains unchanged, and the exposure setting (especially, the shutter speed) remains unchanged, thereby causing an object blur.

Japanese Patent Laid-Open No. 2020-106770 describes a technique of setting exposure so as to prevent an object blur from occurring by calculating a shutter speed adjustment width corresponding to an object blur amount from a preparatory shot image and an actually shot image and adjusting the shutter speed based on the calculation result.

However, in Japanese Patent Laid-Open No. 2020-106770, to adjust the shutter speed, a preparatory shot image and an actually shot image are necessary, and the shutter speed can be adjusted only after an object blur occurs. That is, in a shooting scene in which an object suddenly starts to move, an object blur cannot be suppressed.

### SUMMARY

The present disclosure provides a technique capable of suppressing an object blur in control of an image capturing apparatus.

The present disclosure in its first aspect provides an information processing apparatus for controlling an image capturing apparatus including a photoelectric conversion element configured to generate an image signal by counting a pulse signal corresponding to incidence of light, the information processing apparatus comprising: at least one memory storing instructions; and at least one processor, that upon execution of the stored instructions, is configured to operate as: an exposure period control unit configured to control an exposure period of a main frame based on a main period as the exposure period of the main frame; a blur detection unit configured to detect an object blur for each unit period shorter than the main period by reading out an image signal of an exposed sub-frame for a sub-period from a start of exposure to an end of the unit period; and an output unit configured to output, based on a result of the blur detection, an output signal based on an image signal selected from one of the main frame and the sub-frame.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is an exploded perspective view showing an example of the arrangement of a photoelectric conversion element according to the first embodiment;

FIG. 2 is a view showing an example of the arrangement of a sensor chip according to the first embodiment;

FIG. 3 is a view showing an example of the arrangement of a circuit chip according to the first embodiment;

FIG. 4 is an example of a circuit diagram of an equivalent circuit of a pixel and a signal processing unit according to the first embodiment;

FIG. 5 shows timing charts for explaining the operations of an APD and a waveform shaping unit according to the first embodiment;

FIG. 6 is a functional block diagram of an image capturing apparatus according to the first embodiment;

FIG. 7 is a timing chart of the photoelectric conversion element according to the first embodiment;

FIG. 8 is a flowchart of shooting processing of the image capturing apparatus according to the first embodiment;

FIG. 9 is a flowchart of image capturing processing of an image capturing apparatus according to the second embodiment;

FIG. 10 is a functional block diagram of an image capturing apparatus according to the third embodiment;

FIG. 11 is a flowchart of image capturing processing of the image capturing apparatus according to the third embodiment; and

FIG. 12 is a block diagram showing the hardware arrangement of an information processing apparatus provided in the image capturing apparatus according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

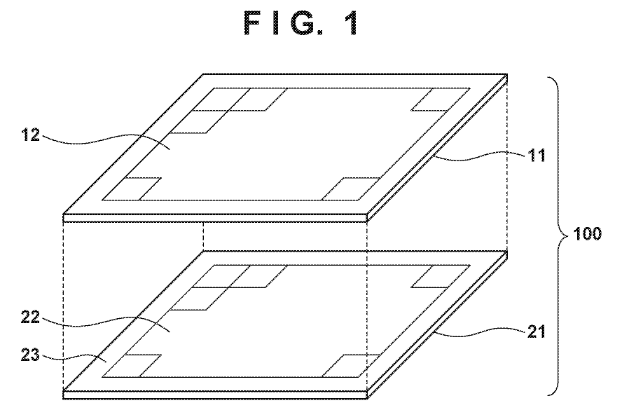

The first embodiment will be described below with reference to the accompanying drawings. The embodiment relates to a technique of controlling an image capturing apparatus that can suppress an object blur. FIG. 1 is an exploded perspective view showing an example of the arrangement of a photoelectric conversion element according to the first embodiment.

A photoelectric conversion element 100 includes two chips, that is, a sensor chip 11 and a circuit chip 21. The sensor chip 11 and the circuit chip 21 are stacked and are electrically connected to each other. The sensor chip 11 includes a pixel region 12. The circuit chip 21 includes a pixel circuit region 22 for processing a signal detected in the pixel region 12, and a readout circuit region 23 for reading out a signal from the pixel circuit region 22.

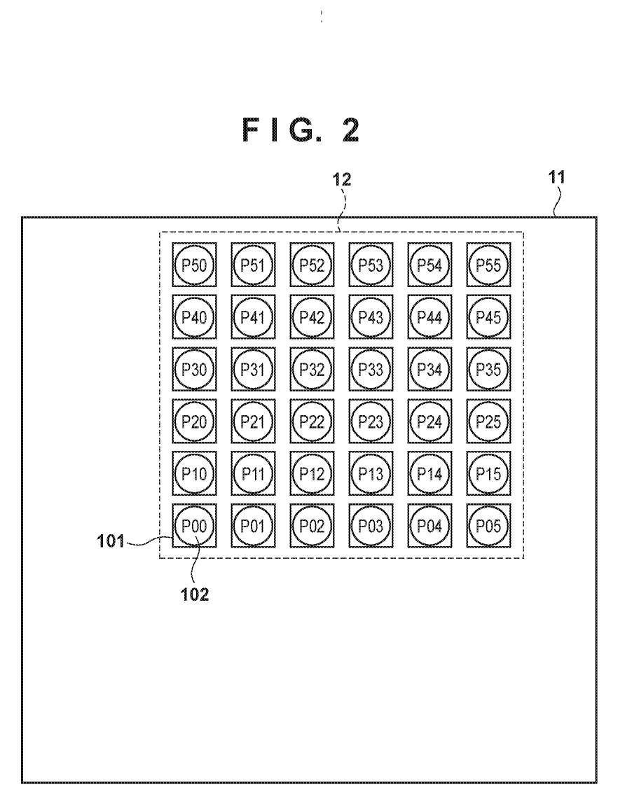

FIG. 2 is a view showing an example of the arrangement of the sensor chip 11 according to the first embodiment.

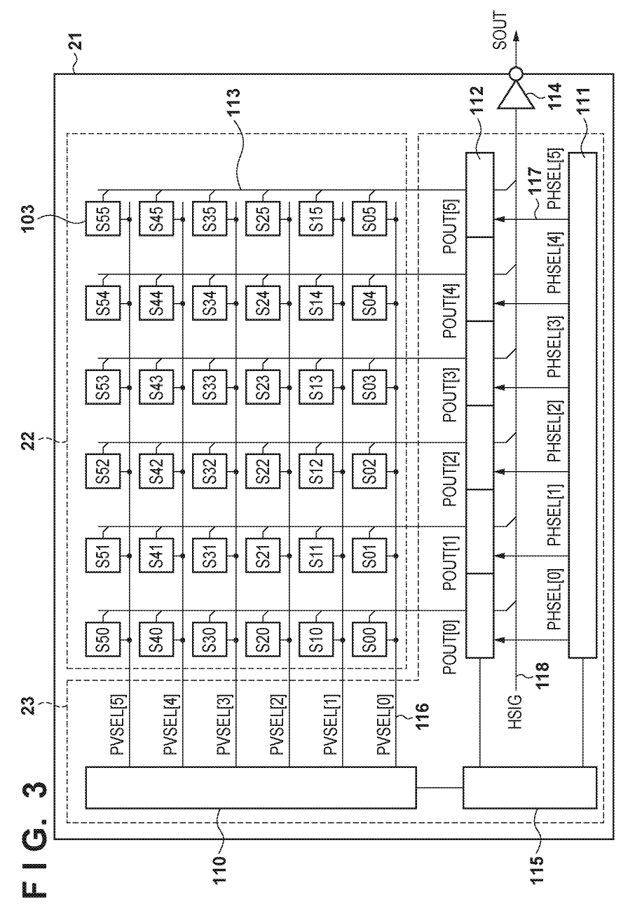

The pixel region 12 of the sensor chip 11 includes a plurality of pixels 101 two-dimensionally arranged over a plurality of rows and a plurality of columns. Each pixel 101 includes a photoelectric conversion unit 102 with an avalanche photodiode (to be also referred to as an APD hereinafter). The photoelectric conversion unit 102 converts incident light into an electrical signal and outputs it. In FIG. 3, 36 pixels 101 arranged in six rows from the 0th row to the fifth row and six columns from the 0th column to the fifth column are assigned with codes each indicating the row number and the column number together with "P". For example, the pixel 101 arranged in the first row and the fourth column is assigned with "P14". Note that the numbers of rows and columns of the pixel array forming the pixel region 12 are not particularly limited.

FIG. 3 is a view showing an example of the arrangement of the circuit chip 21 according to the first embodiment.

The circuit chip 21 includes the pixel circuit region 22 and the readout circuit region 23.

The pixel circuit region 22 includes a plurality of signal processing units 103 two-dimensionally arranged over a plurality of rows and a plurality of columns. The signal processing unit 103 is associated with each pixel. In FIG. 3, 36 signal processing units 103 arranged in six rows from the 0th row to the fifth row and six columns from the 0th column to the fifth column are assigned with codes S00 to S55 each indicating the row number and the column number together with "S". For example, the signal processing unit 103 arranged in the first row and the fourth column is assigned with "S14". Note that the numbers of rows and columns of the array of the signal processing units 103 of the pixel circuit region 22 are not particularly limited.

The readout circuit region 23 includes a vertical scanning circuit 110, a column circuit 112, a horizontal scanning circuit 111, a control pulse generation unit 115, and an output circuit 114.

A control line 116 extends in the first direction (the horizontal direction in FIG. 3). The first direction in which the control line 116 extends will sometimes be referred to as the row direction or the horizontal direction hereinafter. The control line 116 is arranged in each row of the signal processing unit array of the pixel circuit region 22. The control line 116 is connected to each of the signal processing units 103 arranged in the first direction, and supplies a common control signal. Note that in FIG. 3, the control lines 116 are assigned with codes PVSEL[0] to PVSEL[5] each indicating the row number together with "PVSEL". For example, the control line 116 in the first row is assigned with "PVSEL[1]". The control line 116 in each row is connected to the vertical scanning circuit 110.

The vertical scanning circuit 110 supplies a control signal for driving the signal processing unit 103 to the signal processing unit 103 via the control line 116.

A signal line 113 extends in the second direction (the vertical direction in FIG. 3) intersecting the first direction. The second direction in which the signal line 113 extends will sometimes be referred to as the column direction or the vertical direction hereinafter. The signal line 113 is arranged in each column of the array of the signal processing units 103 of the pixel circuit region 22. The signal line 113 is connected to each of the signal processing units 103 arranged in the second direction. In FIG. 3, the signal lines 113 are assigned with codes POUT[0] to POUT[5] each indicating the column number together with "POUT". For example, the signal line 113 in the fourth column is assigned with "POUT4". Each signal line 113 includes n signal lines for outputting an n-bit digital signal. Each signal line 113 is connected to the column circuit 112.

Each column circuit 112 is provided in correspondence with each column of the signal processing unit array of the pixel circuit region 22, and is connected to the signal line 113 in the corresponding column. Each column circuit 112 has a function of holding a signal read out from the signal processing unit 103 via the signal line 113 in the corresponding column.

The horizontal scanning circuit 111 supplies, to each column circuit 112, a control signal for reading out a signal from the column circuit 112. The horizontal scanning circuit 111 supplies a control signal to the column circuit 112 in each column via a control line 117.

Upon receiving the control signal from the horizontal scanning circuit 111, each column circuit 112 outputs the held signal to the output circuit 114 via a horizontal output line 118.

Each control line 117 connects the horizontal scanning circuit 111 and each column circuit 112. In FIG. 3, the control lines 117 are assigned with PHSEL[0] to PHSEL[5] each indicating the column number together with "PHSEL". For example, the control line in the fourth column is assigned with "PHSEL[4]".

The horizontal output line 118 represented by "HSIG" includes n signal lines connected to each column circuit 112 to output an n-bit digital signal. The horizontal output line 118 is connected to the output circuit 114. The horizontal output line 118 outputs, to the output circuit 114, the digital signal output from the column circuit 112.

The output circuit 114 outputs, as an image signal SOUT of the photoelectric conversion element 100, a signal corresponding to the pixel signals output from the column circuits 112.

The control pulse generation unit 115 supplies control signals for controlling the operations and operation timings of the vertical scanning circuit 110, the horizontal scanning circuit 111, and the column circuits 112. Note that at least some of the control signals for controlling the operations and operation timings of the vertical scanning circuit 110, the horizontal scanning circuit 111, and the column circuits 112 may be supplied from the outside of the photoelectric conversion element 100.

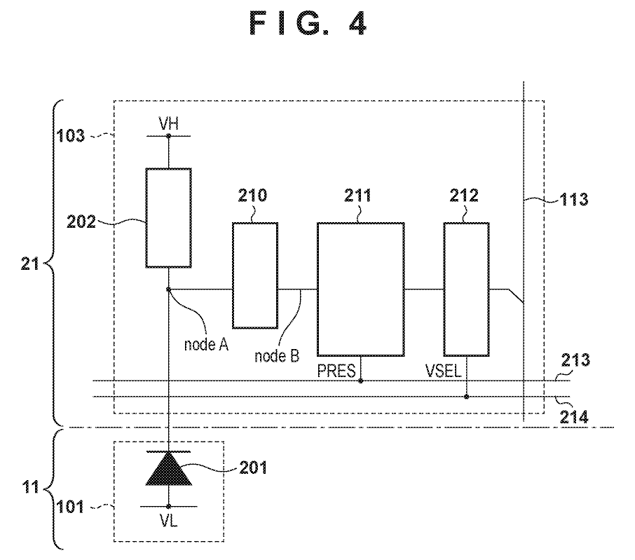

FIG. 4 is an example of a circuit diagram of an equivalent circuit of the pixel 101 and the signal processing unit 103.

The pixel 101 in the sensor chip 11 includes an APD 201 functioning as the photoelectric conversion unit 102. The APD 201 is an abbreviation for Avalanche Photo Diode. When light enters the APD 201, the APD 201 generates, as an electrical signal, charge pairs corresponding to the incident light by photoelectric conversion. The anode of the APD 201 is supplied with a voltage VL (first voltage). The cathode of the APD 201 is supplied with a voltage VH (second voltage) higher than the voltage VL supplied to the anode. The anode and the cathode are supplied with a reverse bias voltage that causes the APD 201 to perform an avalanche multiplication operation. The APD 201 causes avalanche multiplication by charges generated by the incident light in the state in which such reverse bias voltage is supplied, thereby generating an avalanche current.

Note that when a reverse bias voltage is supplied, there are a Geiger mode operated in a state in which the potential difference between the anode and the cathode is larger than the breakdown voltage and a linear mode operated in a state in which the potential difference between the anode and the cathode is around or smaller than the breakdown voltage. An APD operated in the Geiger mode is called a Single-Photon Avalanche Diode (SPAD). For example, the voltage VL is -30 V and the voltage VH is 1 V.

The signal processing unit 103 in the circuit chip 21 includes a quench element 202, a waveform shaping unit 210, a counter circuit 211, and a memory circuit 212.

The quench element 202 is connected to the APD 201 and a power supply for supplying the voltage VH. The quench element 202 has a function of replacing, by a voltage signal, a change of the avalanche current generated in the APD 201. The quench element 202 functions as a load circuit (also called a quench circuit) at the time of signal multiplication by avalanche multiplication, and suppresses the voltage supplied to the APD 201. Thus, the quench element 202 operates to suppress avalanche multiplication, which is also called a quench operation.

The waveform shaping unit 210 outputs a pulse signal by shaping the potential change of the cathode of the APD 201 obtained at the time of detection of a photon. For the waveform shaping unit 210, for example, at least one of an inverter circuit and a buffer circuit is used. A node A shown in FIG. 4 indicates the input side of the waveform shaping unit 210. A node B indicates the output side of the waveform shaping unit 210.

The counter circuit 211 counts a pulse signal corresponding to the incidence of light output from the waveform shaping unit 210. Furthermore, when a control signal PRES is supplied via a control line 213, the counter circuit 211 resets a count value.

In accordance with a control signal VSEL supplied from the vertical scanning circuit 110 shown in FIG. 3 via a control line 214, the memory circuit 212 switches between the electrically connected state and the unconnected state of the counter circuit 211 and the signal line 113. The memory circuit 212 functions as a memory that temporarily stores the count value of the counter circuit 211, and outputs, to the signal line 113, as a signal, the count value of the pixel from the counter circuit 211.

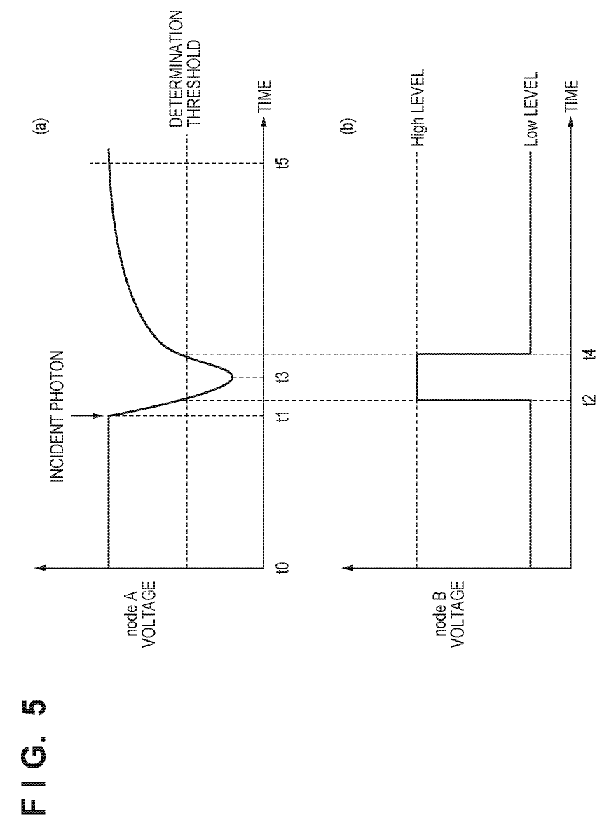

FIG. 5 shows timing charts for explaining the operations of the APD and the waveform shaping unit according to the first embodiment. In FIG. 5, (a) shows the voltage change of the node A shown in FIG. 4. In FIG. 5, (b) shows the voltage change of the node B shown in FIG. 4.

During a period from time t0 to time t1, a voltage of VH - VL is applied to the APD 201 shown in FIG. 4. At this time, the voltage of the node B is at low level. When a photon enters the APD 201 of the photoelectric conversion unit 102 at time t1, an avalanche multiplication current flows through the quench element 202, thereby dropping the voltage of the node A.

When the voltage of the node A becomes lower than a predetermined determination threshold at time t2, the voltage of the node B changes from low level to high level by the function of the waveform shaping unit 210.

When the voltage drop amount further increases and the voltage applied to the APD 201 decreases at time t3, the avalanche multiplication of the APD 201 stops. Thus, the voltage level of the node A does not drop any more from a predetermined value. After that, a current compensating for the voltage drop from the voltage VL flows into the node A, and the voltage of the node A rises.

When the voltage of the node A exceeds the predetermined determination threshold at time t4, the voltage of the node B changes from high level to low level by the function of the waveform shaping unit 210.

After that, as indicated at time t5, the voltage of the node A gradually rises to a predetermined voltage.

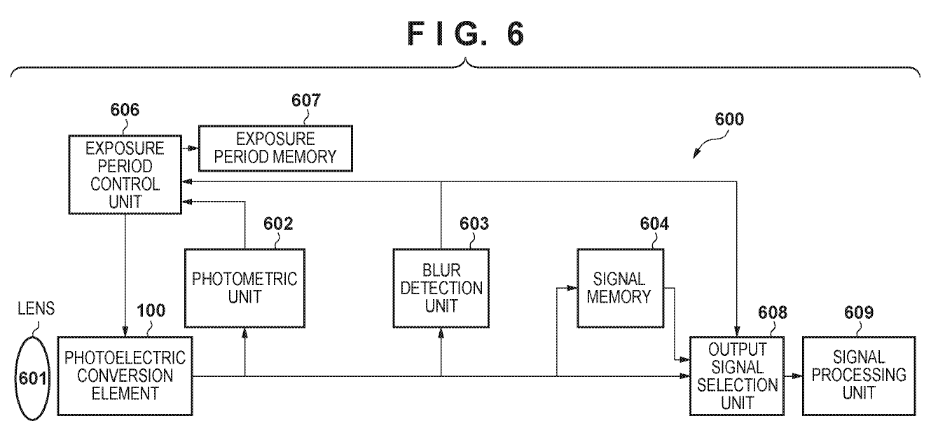

FIG. 6 is a functional block diagram of the image capturing apparatus according to the first embodiment.

An image capturing apparatus 600 includes the photoelectric conversion element 100, a lens 601, a photometric unit 602, a blur detection unit 603, a signal memory 604, an exposure period control unit 606, an exposure period memory 607, an output signal selection unit 608, and a signal processing unit 609. The output signal selection unit 608 and the signal processing unit 609 are examples of an output unit.

The photoelectric conversion element 100 includes the APD 201 described with reference to FIGS. 1 to 5. The photoelectric conversion element 100 receives light condensed by the lens 601, and counts a pulse signal corresponding to the incidence of the light, thereby generating an image signal. The photoelectric conversion element 100 is connected to the photometric unit 602, the blur detection unit 603, the signal memory 604, the exposure period control unit 606, and the output signal selection unit 608.

The photometric unit 602 calculates an exposure amount from the image signal obtained from the photoelectric conversion element 100, calculates an exposure period to obtain proper exposure, and outputs it to the exposure period control unit 606. In the first embodiment, the exposure period calculated by the photometric unit 602 will also be referred to as a main period hereinafter.

The blur detection unit 603 detects an object blur (to be also referred to as a blur hereinafter) from the image signal obtained from the photoelectric conversion element 100. More specifically, the blur detection unit 603 reads out and acquires an image signal for each unit period shorter than the main period. Note that a period from the start of exposure to the end of each unit period will be referred to as a sub-period hereinafter. A frame for a period from the start of exposure to the end of each unit period will also be referred to as a sub-frame hereinafter. The blur detection unit 603 calculates the difference between the image signals of previous and subsequent sub-frames that are temporally adjacent to each other, and determines an object blur when an object moves by pixels the number of which is equal to or larger than a predetermined threshold. The blur detection unit 603 performs motion vector calculation, and determines, if a motion vector amount is equal to or larger than a threshold, that there is an object blur. The blur detection unit 603 outputs blur information indicating the presence/absence of a blur to the exposure period control unit 606 and the output signal selection unit 608. If the blur detection unit 603 detects no blur in the readout sub-frame, the image signal of the sub-frame is stored in the signal memory 604.

The exposure period memory 607 stores information concerning the exposure period. The exposure period memory 607 stores, for example, the main period calculated by the photometric unit 602, the sub-period for determining the presence/absence of a blur by the blur detection unit 603 after the start of exposure, a unit period for setting the sub-period, and the like. Note that the exposure period memory 607 may store, as a main period, an exposure period set by the user, instead of or in addition to the main period calculated by the photometric unit 602.

The exposure period control unit 606 controls the exposure period of the photoelectric conversion element 100. More specifically, the exposure period control unit 606 controls, for example, exposure of the photoelectric conversion element 100 based on the main period calculated by the photometric unit 602, thereby controlling the exposure period of a main frame. The main period may be an exposure period accepted from the user. If the blur detection unit 603 detects a blur, the exposure period control unit 606 stops exposure. On the other hand, if the blur detection unit 603 detects no blur, the exposure period control unit 606 continues exposure until the next sub-period ends. Alternatively, the exposure period control unit 606 may continue exposure of the photoelectric conversion element 100 until the main period calculated by the photometric unit 602 ends. If the blur detection unit 603 detects a blur, an image acquired in a sub-period before the blur is detected may be output. The exposure period control unit 606 may decide the exposure period of the next main frame based on the exposure period in the sub-period before the blur is detected. Thus, the exposure period control unit 606 can implement exposure that can suppress a blur while obtaining a properly exposed image signal.

The signal memory 604 holds the image signal exposed by the photoelectric conversion element 100 in the sub-period and output.

Based on the blur information indicating the presence/absence of a blur as a result of blur detection from the blur detection unit 603, the output signal selection unit 608 selects one of the image signal of the main frame output from the photoelectric conversion element 100 and the image signal of the sub-frame stored in the signal memory 604, and outputs the selected image signal to the signal processing unit 609. For example, if a blur is detected, the output signal selection unit 608 selects the image signal of the sub-frame. On the other hand, if no blur is detected, the output signal selection unit 608 selects the image signal of the main frame. That is, if no blur has been detected in the sub-frames acquired before the exposure period reaches the main period, the output signal selection unit 608 outputs the image signal of the main frame.

The signal processing unit 609 performs various image processes such as digital gain processing, gamma processing, and white balance processing for the image signal output from the output signal selection unit 608 to generate an output signal, thereby outputting the output signal. The signal processing unit 609 may execute some of the above processes or other processes. Furthermore, a subsequent processing unit (not shown) may record data in the memory, and record and display an image and a video signal by an external output device.

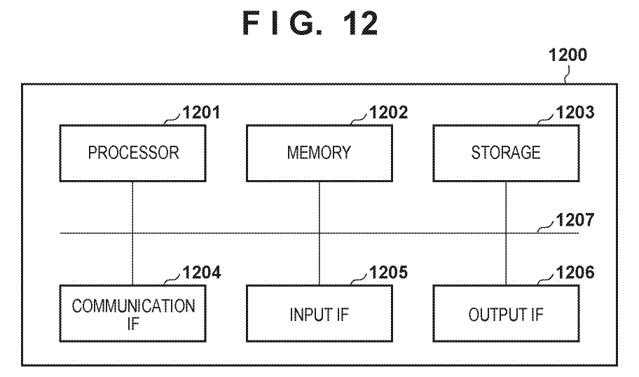

FIG. 12 is a block diagram showing the hardware arrangement of an information processing apparatus 1200 provided in the image capturing apparatus 600. The information processing apparatus 1200 is an example of a computer, and controls the image capturing apparatus 600. The information processing apparatus 1200 of the image capturing apparatus 600 includes a processor 1201, a memory 1202, a storage 1203, a communication IF 1204, an input IF 1205, an output IF 1206, and a bus 1207. The processor 1201, the memory 1202, the storage 1203, the communication IF 1204, the input IF 1205, and the output IF 1206 are connected to be able to transmit/receive information via the bus 1207.

The processor 1201 is an arithmetic processing unit, and is, for example, a Central Processing Unit (CPU). Note that instead of or in addition to the CPU, the information processing apparatus 1200 may include other processors such as a Micro Processing Unit (MPU), a Graphics Processing Unit (GPU), a Neural Processing Unit (NPU), and a Quantum Processing Unit (QPU). The processor 1201 reads out programs stored in the storage 1203, and deploys them in the memory 1202, thereby implementing various functions. For example, by loading programs, the processor 1201 implements some or all of the functions of the photometric unit 602, the blur detection unit 603, the exposure period control unit 606, the output signal selection unit 608, and the signal processing unit 609. Note that some or all of the functions of the photometric unit 602, the blur detection unit 603, the exposure period control unit 606, the output signal selection unit 608, and the signal processing unit 609 may be implemented by one or a plurality of circuits such as an Application Specific Integrated Circuit (ASIC) and a Programmable Logic Device (PLD) including a Field Programmable Gate Array (FPGA).

The memory 1202 is, for example, a storage device capable of high-speed read/write such as a Random Access Memory (RAM). The memory 1202 functions as a work area when the processor 1201 executes a program. The memory 1202 temporarily stores programs and parameters necessary to execute the programs.

The storage 1203 is, for example, a nonvolatile storage device such as a Hard Disk Drive (HDD) and a Solid State Drive (SSD). The storage 1203 holds programs, parameters necessary to execute the programs, the result of execution of the programs, and the like even in a state in which no power is supplied.

The communication IF 1204 is an interface for implementing communication with an external apparatus via a wired or wireless network.

The input IF 1205 is an interface for accepting input of information from an input device. The input device is, for example, a shutter button, a touch panel, a mouse, a keyboard, or the like.

The output IF 1206 is an interface for outputting information to an external apparatus. The external apparatus is, for example, a display device such as a display.

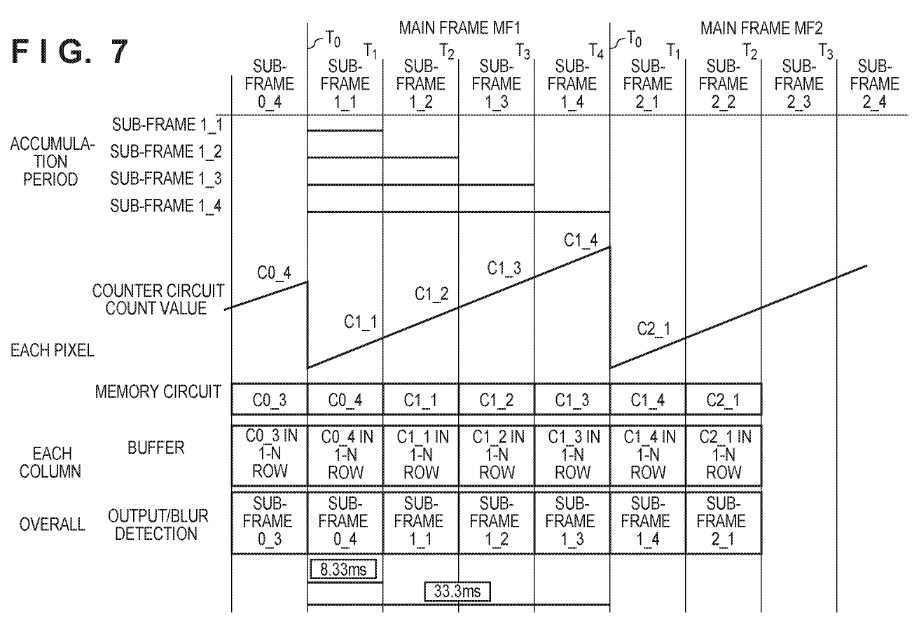

FIG. 7 is a timing chart for explaining a photoelectric conversion method of the photoelectric conversion element 100 according to the embodiment. The blur detection unit 603 according to this embodiment generates sub-frames 1_1, 1_2, 1_3, and 1_4 from a main frame MF1 based on a unit period shorter than the main period of the main frame. The unit period may be a period obtained by uniformly dividing (into four periods in this example) a main period of 33.3 ms as the exposure period of one main frame MF1 or MF2. A time from time Tn to time Tn+1, which is a unit period, may be, for example, 8.33 ms (≈ 33.3/4). As shown in FIG. 7, the main period of the main frame MF1 and the sub-periods as the exposure periods of the sub-frames 1_1, 1_2, 1_3, and 1_4 are integer multiples of the divided unit period. The blur detection unit 603 according to this embodiment reads out, for each unit period, the image signal of the sub-frame exposed during the sub-period from the start of exposure to the end of the unit period, and detects an object blur for each sub-frame.

The sub-frame 1_1 has an exposure period equal to the unit period from time T0, at which exposure of the main frame MF1 starts, to time T1. The sub-frame 1_2 has an exposure period from time T0 to time T2, which is twice the unit period. The sub-frame 1_3 has an exposure period from time T0 to time T3, which is three-times the unit period. The sub-frame 1_4 has an exposure period from time T0 to time T4, which is equal to the exposure period of the main frame and is four times the unit period. Therefore, the sub-frame 1_4 is also the main frame.

The counter circuit 211 resets the count value at time T0, and restarts counting the pulse signal. The memory circuit 212 acquires count values C1_1, C1_2, C1_3, and C1_4 from the counter circuit 211 at times T1 to T4, respectively. The memory circuit 212 temporarily stores the count values C1_1, C1_2, C1_3, and C1_4. Then, the memory circuit 212 sequentially outputs the temporarily stored image signals for one row from the photoelectric conversion element 100 via the buffers of the column circuits 112. As described above, according to this embodiment, the memory circuit 212 reads out and outputs, from time T1 to time T2, the image signals accumulated during the period of the sub-frame 1_1, and the blur detection unit 603 processes the image signals. Similarly, the memory circuit 212 sequentially reads out and outputs, from time T2 to time T3, from time T3 to time T4, and from time T4 to time T1, the image signals accumulated during the periods of the sub-frames 1_2, 1_3, and 1_4, respectively, and the blur detection unit 603 processes the image signals.

As described above, the exposure period according to this embodiment includes the plurality of sub-periods and the main period in one main frame. The sub-period is shorter than the main period. The photoelectric conversion element 100 outputs, from the end of each sub-period to the end of the main period, the image signals generated in each sub-period. In this embodiment, the sub-period overlaps at least a part of the main period. In the plurality of sub-periods and the main period, exposure starts simultaneously. Furthermore, the end of the main period is a break of the main frames. The sub-periods and the main period are integer multiples of the unit period.

In this embodiment, since the APD 201 is used, exposure periods can overlap each other because of no readout noise unlike a Complementary Metal Oxide Semiconductor (CMOS) sensor. That is, an original signal does not deteriorate no matter how many times it is read out in one main frame. This embodiment describes an example of reading out a signal four times in one main frame, but the number of times of reading out the sub-frame may be increased/decreased in consideration of the processing time of blur detection and the like.

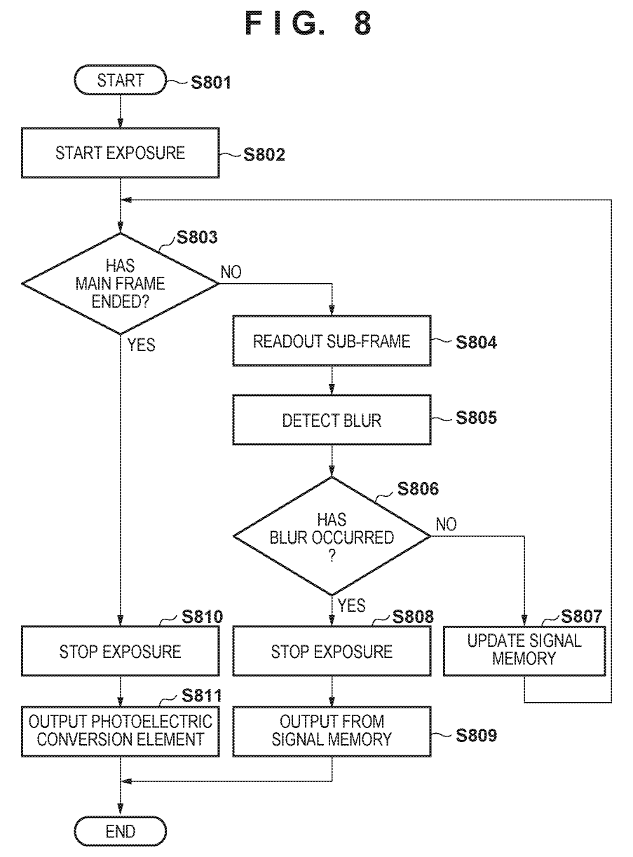

FIG. 8 is a flowchart of shooting processing of the image capturing apparatus according to the first embodiment. A detailed operation according to this embodiment will be described together with the timing chart shown in FIG. 7.

Before the start of the flowchart of the image capturing processing, the exposure period control unit 606 sets the main period in shooting as an exposure period. For example, the exposure period control unit 606 may set the main period by accepting an input from the user via the input IF 1205 in the state of the shooting mode of the image capturing apparatus 600. The exposure period control unit 606 may adopt the main period calculated based on a photometric result by the photometric unit 602 so as to obtain proper exposure. The exposure period control unit 606 may accept the change of the composition by the user, and execute a preparatory shooting operation and the like for confirming exposure before shooting.

In step S801, the exposure period control unit 606 starts shooting processing. The exposure period control unit 606 may start the shooting processing at a timing when the user presses the shutter button.

In step S802, upon accepting the pressing of the shutter button by the user, the exposure period control unit 606 starts exposure. The start timing may be time T0 shown in FIG. 7. The general image capturing apparatus 600 controls the photoelectric conversion element 100 so as to obtain the exposure period decided in advance, thereby outputting the image signal. However, the exposure period control unit 606 according to this embodiment controls exposure based on the sub-periods and the main period to cause the photoelectric conversion element 100 to output the image signal. The main period may be the exposure period calculated by the photometric unit 602 or the exposure period accepted from the user.

In step S803, the exposure period control unit 606 determines whether one main frame has ended. For each unit period, that is, every time the sub-frame ends, the exposure period control unit 606 determines whether the main frame has ended. In other words, the exposure period control unit 606 determines whether the main frame has ended, at each of times T1, T2, T3, and T4 in FIG. 7. If the exposure period control unit 606 determines that the main frame has ended at time T4, the process advances to step S810. On the other hand, the exposure period control unit 606 determines that the main frame has not ended at time T1, T2, or T3, and the process advances to step S804.

In step S804, the blur detection unit 603 reads out the image signal of the sub-frame from the photoelectric conversion element 100.

In step S805, the blur detection unit 603 detects an object blur in the sub-frame based on the readout image signal. The blur detection unit 603 may detect a blur by calculating the difference between the previous and subsequent sub-frames. For example, the blur detection unit 603 may calculate the difference between the sub-frames 1_1 and 1_2, and detect a blur by determining, based on the difference, whether the object moves exceeding a threshold.

In step S806, the blur detection unit 603 determines whether a blur has occurred in the image signal of the sub-frame. If the blur detection unit 603 determines that no blur has occurred, the process advances to step S807. On the other hand, if the blur detection unit 603 determines that a blur has occurred, it outputs, to the exposure period control unit 606 and the output signal selection unit 608, blur information indicating that the blur has been detected, and the process advances to step S808.

In step S807, based on the image signal acquired from the photoelectric conversion element 100, the blur detection unit 603 updates the image signal stored in the signal memory 604. Thus, the image signal stored in the signal memory 604 is updated by the newly acquired image signal of the sub-frame in which no blur has occurred. Note that the blur detection unit 603 may store the image signals of the plurality of sub-frames in the signal memory 604. That is, the blur detection unit 603 may accumulate, in the signal memory 604, the newly acquired image signal in which no blur has occurred. Thus, the blur detection unit 603 can store, in the signal memory 604, the image signals of the sub-frames with different exposure periods, in which no blur has occurred. In this case, every time exposure in the main period ends, the blur detection unit 603 may delete the image signals of the sub-frames accumulated in the signal memory 604. Alternatively, when the number of accumulated sub-frames reaches a predetermined number, the blur detection unit 603 may reset the signal memory 604.

After that, the processing from steps S803 to step S807 is executed until the exposure period of the main frame is reached or the blur detection unit 603 detects a blur.

In step S808, when the exposure period control unit 606 acquires, from the blur detection unit 603, the information indicating that a blur has been detected, it stops exposure of the photoelectric conversion element 100.

In step S809, the output signal selection unit 608 selects the image signal based on the blur information of the blur detection unit 603, and outputs an output signal. In this example, since the blur information indicates that a blur has been detected, the output signal selection unit 608 selects the image signal of the sub-frame stored in the signal memory 604. The sub-frame stored in the signal memory 604 is a sub-frame immediately before the sub-frame in which the blur has been detected. Therefore, the output signal selection unit 608 can output an output signal of an image of the sub-frame without any blur. Note that after performing the image processing for the image signal, the signal processing unit 609 may output the thus obtained signal as an output signal. If the plurality of sub-frames are accumulated in the signal memory 604, as described above, the output signal selection unit 608 need not select a sub-frame immediately before the sub-frame in which the blur has been detected. That is, the output signal selection unit 608 may select an image of a sub-frame preceding by two or more sub-frames. At this time, the output signal selection unit 608 may select one of the plurality of accumulated sub-frames by determining whether the sub-frame satisfies a desired condition. Alternatively, the plurality of sub-frames may be arranged and displayed on a display unit (not shown), and the user may make a selection. The above-described "desired condition" may include a condition concerning at least one of the brightness of the image signal and the recognition ratio of the object. For example, under the desired condition, the output signal selection unit 608 need only select at least one of the plurality of sub-frames, in which the brightness of the image signal falls within a predetermined range. The predetermined range may be a range within which proper exposure is obtained or a range designated by the user. Furthermore, the output signal selection unit 608 may select two or more of the sub-frames stored in the signal memory 604, execute image processing for them, and then display the sub-frames on a display unit (not shown). More preferably, the output signal selection unit 608 also displays, on the display unit, the exposure periods respectively corresponding to the sub-frames, thereby providing an index for the user to select a sub-frame. Thus, the image capturing apparatus 600 can not only generate an image with a suppressed blur but also perform preferable exposure control.

In step S810, since it is determined in step S803 that the period of the main frame has ended, the exposure period control unit 606 stops exposure, and outputs, to the output signal selection unit 608, information indicating that the period of the main frame has ended.

In step S811, since the period of the main frame has ended, the output signal selection unit 608 acquires the image signal output from the photoelectric conversion element 100, and outputs, as an output signal, an image signal obtained after the signal processing unit 609 performs image processing for the image signal.

As described above, in the first embodiment, one of the main frame and the sub-frames whose exposure periods are shorter than that of the main frame is selected based on the result of blur detection, and an output signal is output, thereby making it possible to perform shooting while suppressing an object blur.

According to the first embodiment, in a case where a blur is detected, the image signal of a sub-frame before the blur is detected is selected, and it is thus possible to output an output signal of an image without any blur.

According to the first embodiment, in a case where no blur is detected, the image signal of a sub-frame is stored. Thus, it is possible to readily generate an output signal and output it based on the image signal of the previous sub-frame when a blur is detected.

According to the first embodiment, since the main period and the sub-periods are controlled by integer multiples of the unit period, the load of the processing can be reduced.

### Second Embodiment

The first embodiment has explained an example of obtaining an image signal without any object blur in output of an image signal of one frame. The second embodiment will describe an example of obtaining an image without any object blur in output of image signals of consecutive frames like a moving image and continuously shot still images, and adjustment of a sub-frame image. In the second embodiment, the same components as in the first embodiment are provided. Therefore, in the second embodiment, a description of the same components as in the first embodiment will be omitted or simplified.

If an exposure period control unit 606 according to the second embodiment compares an exposure period (to be also referred to as a storage period hereinafter) based on blur detection stored in an exposure period memory 607 with a determination exposure period, and determines that the determination exposure period is longer, the storage period is set as the main period in next shooting. The storage period may be the longest sub-period among sub-periods in which no blur has been detected in a previous frame. The previous frame is a main frame or a sub-frame output in a previous main period among consecutive frames obtained by shooting a moving image or continuously shooting still images. Therefore, the previous frame is not a previous sub-frame in a plurality of sub-frames included in the one current main frame. The determination exposure period may be one of an exposure period calculated by performing photometry by a photometric unit 602 and an arbitrary exposure period set by the user in the shooting mode of the image capturing apparatus described in the first embodiment. That is, it can be said that the determination exposure period is not the storage period. Thus, in this embodiment, the effect of preventing an object blur in next shooting is improved. If no blur has been detected in the previous frame or if a blur has been detected and it is determined that the determination exposure period is not longer than the storage period, the exposure period control unit 606 controls exposure of next shooting by setting the determination exposure period as the main period. The exposure period control unit 606 according to this embodiment controls a photoelectric conversion element 100 based on two exposure periods of the sub-period and the main period.

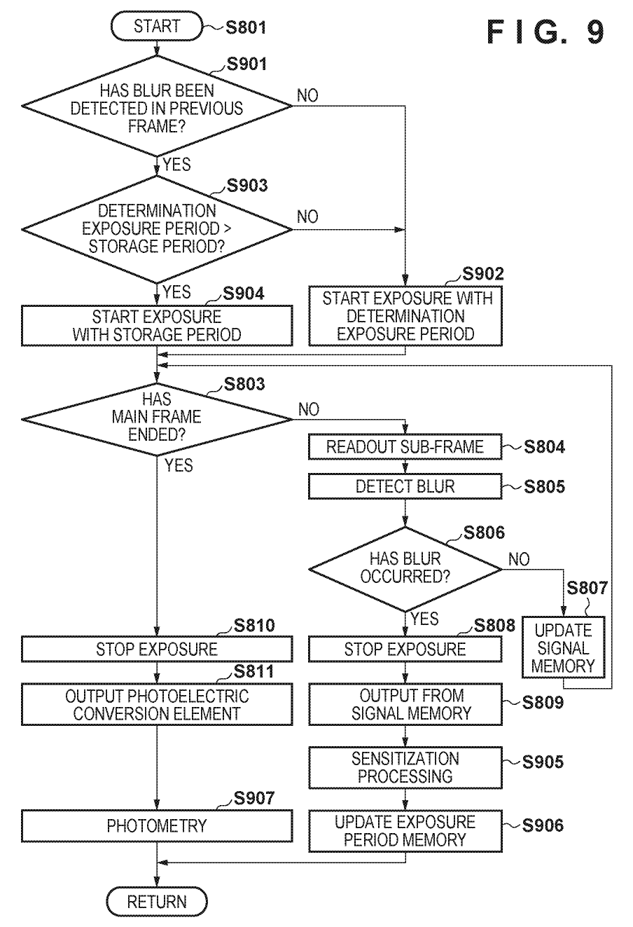

FIG. 9 is a flowchart of image capturing processing of an image capturing apparatus according to the second embodiment. Note that a description of the same steps as in the flowchart shown in FIG. 8 will be simplified or omitted.

In step S901, the exposure period control unit 606 refers to blur information indicating whether a blur detection unit 603 has detected a blur in a previous frame. If the exposure period control unit 606 determines that no blur has been detected in the previous frame or that the current frame is the first frame when a shutter button is pressed and there is no previous frame, the process advances to step S902.

In step S902, the exposure period control unit 606 starts exposure by setting the determination exposure period as the main period. For example, the exposure period control unit 606 starts exposure for the exposure period calculated by the photometric unit 602.

On the other hand, if the exposure period control unit 606 determines in step S901 that a blur has been detected in the main frame during the previous main period, a blur highly probably occurs in the current main frame, the process thus advances to step S903, and the exposure period control unit 606 refers to the storage period stored in the exposure period memory 607.

In step S903, the exposure period control unit 606 determines whether the determination exposure period is longer than the storage period stored in the exposure period memory 607. If the exposure period control unit 606 determines that the determination exposure period is not longer than the storage period, the process advances to step S902. On the other hand, if the exposure period control unit 606 determines that the determination exposure period is longer than the storage period, the process advances to step S904.

In step S904, the exposure period control unit 606 starts exposing the current main frame by setting, as the main period, the storage period stored in the exposure period memory 607.

After that, the blur detection unit 603 and the exposure period control unit 606 read out a sub-frame, similarly to steps S803 to S807 of the first embodiment, perform blur detection for each sub-frame, and update, in a case where no blur has been detected, an image signal in a signal memory 604.

On the other hand, the blur detection unit 603, the exposure period control unit 606, and the output signal selection unit 608 read out a sub-frame, similarly to steps S803 to S809 of the first embodiment. If a blur has been detected in the sub-frame, the exposure period control unit 606 stops exposure, and an output signal selection unit 608 acquires the image signal from the signal memory 604 and outputs it. The sub-frame is exposed for the sub-period shorter than the main period. Thus, if the exposure period (that is, the main period) is set so that the image signal of the main frame output in the main period is properly exposed, the image signal of the sub-frame output in the sub-period presents an image darker than the image of the main frame shot in the main period.

Therefore, in step S905, a signal processing unit 609 performs sensitization processing for the image signal of the sub-frame to generate an output signal, thereby outputting the output signal. More specifically, the signal processing unit 609 performs sensitization processing of multiplying the image signal of the sub-frame by a ratio (= main period/longest sub-period among sub-periods in which no blur has been detected). The sub-period of the denominator is also the exposure period of the output sub-frame. In other words, the sub-period is the sub-period of the sub-frame before the sub-frame in which a blur has been detected. Thus, the signal processing unit 609 compensates for underexposure caused by shortening of the exposure period, and generates a properly exposed output signal without any object blur.

In step S906, the exposure period control unit 606 stores, as the storage period, the longest sub-period among the sub-periods in which no blur has occurred in the exposure period memory 607, thereby updating the stored storage period. In other words, the exposure period control unit 606 stores, as the storage period, the sub-period before the sub-period in which a blur has occurred in the exposure period memory 607. The exposure period control unit 606 sets, as one of options for the exposure period of the next main frame, the storage period newly stored in the exposure period memory 607. In a case where the object moves and a blur is detected, if the exposure period equal to the current exposure period is set as the main period, it is expected that the object will similarly move in the next main frame. In this case, the exposure period control unit 606 can suppress an object blur in shooting of the next main frame by using, as the exposure period (that is, the main period) of the next main frame, the storage period stored in the exposure period memory 607.

If the blur detection unit 603 has detected no object blur before the end of the main frame, the exposure period control unit 606 stops exposure, similarly to steps S803 to S811 of the first embodiment. Then, the output signal selection unit 608 outputs an output signal based on the image signal from the photoelectric conversion element 100, and the process advances to step S907.

In step S907, the photometric unit 602 calculates an exposure period from the image signal by performing photometry to obtain proper exposure for the next main frame, and outputs the calculated exposure period as a determination exposure period to the exposure period control unit 606. The exposure period control unit 606 may adjust the exposure period of the next main frame based on the determination exposure period.

According to the second embodiment, in a case where a blur has been detected in a previous frame and the determination exposure period is longer than the stored storage period, exposure is performed based on the storage period as an exposure period in which no blur has been detected. Thus, in the second embodiment, even if a blur has been detected in the previous frame, it is possible to surely suppress a blur in the next frame.

According to the second embodiment, in a case where a blur has been detected in a previous frame and the determination exposure period is shorter than the stored storage period, exposure is performed by setting the determination exposure period as the main period, and thus it is possible to perform exposure for an appropriate exposure period or an exposure period desired by the user while suppressing a blur.

According to the second embodiment, since sensitization processing is performed for the image signal of the sub-frame, even if the exposure period is shortened, it is possible to output a high-quality output signal.

### Third Embodiment

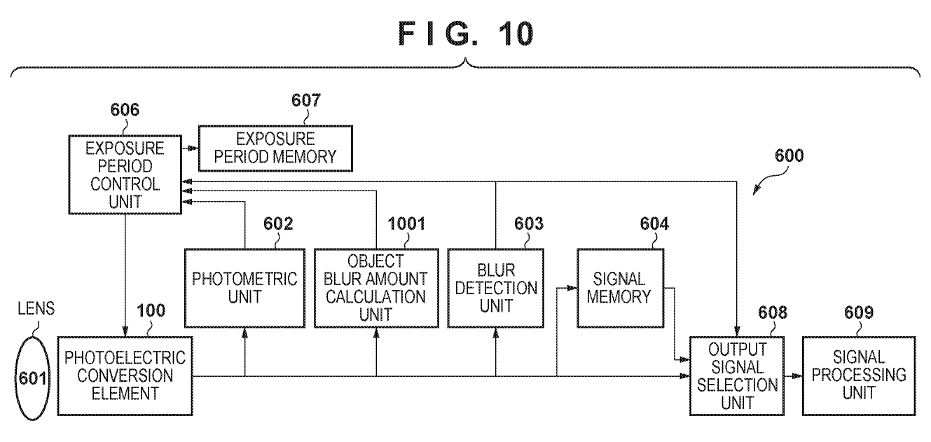

FIG. 10 is a functional block diagram of an image capturing apparatus according to the third embodiment. As shown in FIG. 10, an image capturing apparatus 600 according to the third embodiment includes an object blur amount calculation unit 1001 in addition to the components illustrated in the block diagram of FIG. 6.

The object blur amount calculation unit 1001 calculates an object blur amount based on image signals output from a photoelectric conversion element 100, then calculates, as an allowable exposure period, an exposure period that suppresses an object blur, and outputs it to an exposure period control unit 606.

The object blur amount calculation unit 1001 may calculate an object blur amount by, for example, a method using a motion vector. The object blur amount calculation unit 1001 may calculate a motion vector using temporally adjacent image signals. The temporally adjacent image signals may be image signals of sub-frames 1_1 and 1_2 of FIG. 7 or image signals of main frames MF1 and MF2. However, if the sub-frames are used, the exposure periods of the image signals are different from each other. Therefore, in this case, a signal processing unit 609 may perform in advance sensitization or desensitization processing for the image signal so as to adjust exposure to one of the image signals, and output the image signal to the object blur amount calculation unit 1001.

The object blur amount calculation unit 1001 may calculate a motion vector using a block matching method or a gradient method. If the block matching method is used, the object blur amount calculation unit 1001 may divide each image signal into an arbitrary number of blocks and perform correlation calculation for each block. The object blur amount calculation unit 1001 may calculate a moving amount between the temporally adjacent images, that is, an object blur amount by using a correlation calculation result as a motion vector.

The object blur amount calculation unit 1001 may calculate the allowable exposure period of the next main frame based on the calculated object blur amount. In this example, the object blur amount calculation unit 1001 calculates such allowable exposure period that the object blur is eliminated in the next main frame. The object blur amount calculation unit 1001 can set, as the allowable exposure period, a time whose product with the object blur amount falls within a blur allowable pixel count. Since the object blur amount represents the number of pixels by which the object has moved per unit period, the object blur amount calculation unit 1001 calculates the object blur amount based on the time difference between the images for which the motion vector has been calculated, and the motion vector. The object blur amount calculation unit 1001 sets the allowable exposure period so as to satisfy the following condition.

allowable exposure period ≤ blur allowable pixel count/object blur amount

Note that since the exposure period settable in the image capturing apparatus is discrete, the object blur amount calculation unit 1001 may reset the main period so as to satisfy the above allowable exposure period and obtain an exposure period settable in the image capturing apparatus.

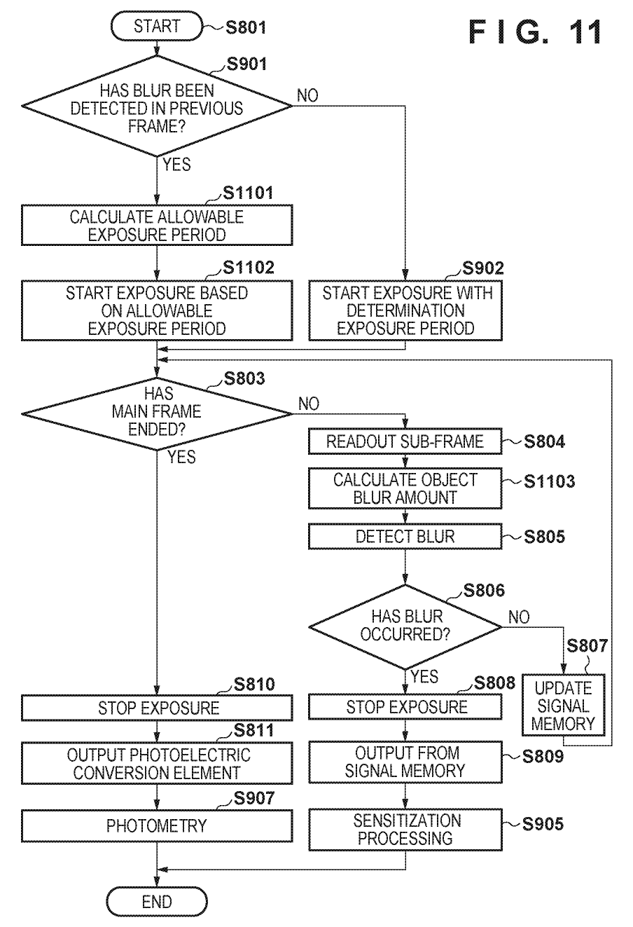

FIG. 11 is a flowchart of image capturing processing of the image capturing apparatus according to the third embodiment. Note that a description of the same steps as in FIGS. 8 and 9 will be simplified or omitted.

In the third embodiment, if a blur has been detected in the frame for the previous main period, the object blur amount calculation unit 1001 calculates an allowable exposure period in step S1101. More specifically, in step S1103 of the processing of the frame for the previous main period, the object blur amount calculation unit 1001 calculates an object blur amount for each sub-frame, and calculates an allowable exposure period based on the object blur amount. In this example, the flowchart of calculating an object blur amount for each sub-frame by the object blur amount calculation unit 1001 is shown. Note that if an object blur amount is calculated for each main frame, the object blur amount calculation unit 1001 may calculate an object blur amount before the start of exposure of the next main frame after step S811 or S809, thereby calculating an allowable exposure period.

In step S1102, the exposure period control unit 606 sets the exposure period (that is, the main period) of the main frame based on the allowable exposure period calculated by the object blur amount calculation unit 1001, and starts exposure. If the allowable exposure period can be set as the main period, the exposure period control unit 606 may set the allowable exposure period as the main period. On the other hand, if the allowable exposure period cannot be set as the main period, the exposure period control unit 606 may set, as the main period, a period shorter than the allowable exposure period. This allows such shooting that an object blur falls within an allowable range.

As described above, in the third embodiment, exposure is controlled based on the object blur amount in the main period based on the allowable exposure period. Thus, in the third embodiment, even if a blur has occurred in a previous frame, it is possible to suppress a blur while increasing the exposure period within an allowable range.

According to the third embodiment, if no blur has been detected in a previous frame, exposure is performed by setting the determination exposure period as the main period. Therefore, it is possible to perform exposure for an appropriate exposure period or an exposure period desired by the user while suppressing a blur.

According to the present disclosure, it is possible to suppress an object blur in control of an image capturing apparatus.

### Other Embodiments

The technical concept of the present disclosure is not limited to the disclosed exemplary embodiments, and is intended to encompass various modifications to the exemplary embodiments or replacement by the equivalent structures and functions. The scope of the following claims is to be accorded the broadest interpretation so as to encompass all such modifications and equivalent structures and functions.

Some of the above-described embodiments may be combined appropriately. Note that a detection method based on a motion vector has been described as a method of detecting an object blur, but the present disclosure is not limited to this, and a region where a difference amount between the image signals of temporally adjacent frames is equal to or larger than a given threshold may be detected as an object blur.

The above-described embodiments may be combined. In a case where the embodiments are combined, the user may be able to select the arrangement or processing of one of the embodiments or an information processing apparatus may automatically make settings.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-010643, filed January 24, 2025, which is hereby incorporated by reference herein in its entirety.

What is claimed is:

1. An information processing apparatus for controlling an image capturing apparatus including a photoelectric conversion element configured to generate an image signal by counting a pulse signal corresponding to incidence of light, the information processing apparatus comprising:
at least one memory storing instructions; and
at least one processor, that upon execution of the stored instructions, is configured to operate as:
an exposure period control unit configured to control an exposure period of a main frame based on a main period as the exposure period of the main frame;
a blur detection unit configured to detect an object blur for each unit period shorter than the main period by reading out an image signal of an exposed sub-frame for a sub-period from a start of exposure to an end of the unit period; and
an output unit configured to output, based on a result of the blur detection, an output signal based on an image signal selected from one of the main frame and the sub-frame.

2. The apparatus according to claim 1, wherein
in a case where no blur has been detected, the output unit selects the image signal of the main frame, and
in a case where a blur has been detected, the output unit selects the image signal of the sub-frame before the blur is detected.

3. The apparatus according to claim 1, wherein the main period and the sub-period are integer multiples of the unit period.

4. The apparatus according to claim 1, wherein in a case where no blur has been detected in the readout sub-frame, the blur detection unit stores the image signal of the sub-frame.

5. The apparatus according to claim 4, wherein
in a case where the blur has been detected,
the exposure period control unit stops exposure, and
the output unit outputs the output signal based on the stored image signal of the sub-frame.

6. The apparatus according to claim 1, wherein
a determination exposure period is one of an exposure period calculated by photometry and an exposure period set by a user,
in a case where a blur has been detected in a previous main period, the exposure period control unit stores, as a storage period, a longest sub-period among sub-periods in which no blur has been detected after the start of exposure, and
in a case where the blur has been detected in the previous main period and the determination exposure period is longer than the storage period, the exposure period control unit controls exposure by setting the storage period as the main period.

7. The apparatus according to claim 1, wherein
a determination exposure period is one of an exposure period calculated by photometry and an exposure period set by a user,
in a case where a blur has been detected in a previous main period, the exposure period control unit stores, as a storage period, a longest sub-period among sub-periods in which no blur has been detected after the start of exposure, and
in one of a case where no blur has been detected in the previous main period and a case where the determination exposure period is not longer than the storage period, the exposure period control unit controls exposure by setting the determination exposure period as the main period.

8. The apparatus according to claim 1, wherein in a case where a blur has been detected, the output unit executes sensitization processing for the image signal of the sub-frame.

9. The apparatus according to claim 8, wherein the output unit executes the sensitization processing by multiplying the image signal by a ratio (= main period/longest sub-period among sub-periods in which no blur has been detected).

10. The apparatus according to claim 1, further comprising a blur amount calculation unit configured to calculate, based on a blur amount in a previous main period, as an allowable exposure period, an exposure period whose product with the blur amount is smaller than a predetermined threshold,
wherein in a case where a blur has been detected in a previous main period, the exposure period control unit controls exposure for a main period based on the allowable exposure period.

11. The apparatus according to claim 10, wherein
a determination exposure period is one of an exposure period calculated by photometry and an exposure period set by a user, and
in a case where no blur has been detected in a previous main period, the exposure period control unit controls exposure for the determination exposure period.

12. An image capturing apparatus comprising:
an information processing apparatus defined in claim 1;
a plurality of pixels each including a photoelectric conversion unit configured to convert light into an electrical signal; and
a processing unit associated with each pixel and including a waveform shaping unit configured to generate a pulse based on a signal from an image, a counter unit configured to start counting the pulse upon receiving the pulse and to count the number of pulses as a count value, and a memory configured to record the count value as the image signal.

13. An information processing method of controlling an image capturing apparatus including a photoelectric conversion element configured to generate an image signal by counting a pulse signal corresponding to incidence of light, the method comprising:
controlling an exposure period of a main frame based on a main period as the exposure period of the main frame;
detecting an object blur for each unit period shorter than the main period by reading out an image signal of an exposed sub-frame for a sub-period from a start of exposure to an end of the unit period; and
outputting, based on a result of the blur detection, an output signal based on an image signal selected from one of the main frame and the sub-frame.

14. A non-transitory computer-readable storage medium storing a computer program that, when read and executed by a computer for controlling an image capturing apparatus including a photoelectric conversion element configured to generate an image signal by counting a pulse signal corresponding to incidence of light, causes the computer to:
control an exposure period of a main frame based on a main period as the exposure period of the main frame;
detect an object blur for each unit period shorter than the main period by reading out an image signal of an exposed sub-frame for a sub-period from a start of exposure to an end of the unit period; and
output, based on a result of the blur detection, an output signal based on an image signal selected from one of the main frame and the sub-frame.
